(19) United States
(12) Patent Application Publication
(10) Pub. No.: US 2015/0327073 A1
(43) Pub. Date: Nov. 12, 2015

(54) Controlling Access of a User Equipment to Services

(71) Applicant: Telefonaktiebolaget L M Ericson (publ), Stockholm (SE)

(72) Inventors: Stefan Rommer, Västra Frölunda (SE); Emiliano Merino Vazquez, Leganés, Madrid (ES); Marta Montejo Ayala, Getafe (Madrid) (ES); Tomas Muehlhoff, Herzogenrath (DE); Angel Navas Cornejo, Leganés (ES); Gema Segura Cava, Madrid (ES)

(21) Appl. No.: 14/763,952

(22) PCT Filed: Jan. 29, 2013
(86) PCT No.: PCT/EP2013/051659

§ 371 Date: Jul. 28, 2015

(51) Int. Cl. H04W 12/08; H04W 60/02; H04L 29/06; H04W 4/02

(52) U.S. Cl. CPC H04W 12/08; H04W 4/02; H04W 60/02; H04L 63/0876

(57) ABSTRACT

This invention relates to methods, user equipment, access controller, and equipment identity register for controlling access of a user equipment, UE, (100) to services provided by a communication network (101). The UE (100) is adapted to support at least a first access technology (202), said at least first access technology (202) is associated with at least one first equipment identifier (206), and said first equipment identifier uniquely identifies the UE (100). The method comprises the first steps of receiving a network access request to services via said first access technology (202), said network access request comprising said first equipment identifier (206). The method comprises the second steps of receiving at least one additional equipment identifier not related to said first access technology (202), said additional equipment identifier uniquely identifying the UE (100). The method comprises the third steps of and controlling the UE's (100) access to the services based on the received information.

### TECHNICAL FIELD

The present invention relates to controlling the access of a user equipment, UE, to services provided by a communication system.

### BACKGROUND

The recent success of mobile smartphones has also boosted the use of mobile packet data. This increased traffic demand has not only hit the traditional mobile networks based on the 3^{rd} Generation Partnership Project, 3GPP, access technologies, but has also caused to include Wireless Local Area Network, WLAN, access technologies into the overall radio framework for mobile packet access.

3GPP has specified the access network selection, including authentication and access authorization using Authentication, Authorization and Accounting, AAA procedures, used for the interworking of the 3GPP system and WLANs.

In addition to these, 3GPP also specifies the tunnel management procedures used for establishing an end-to-end tunnel from the WLAN User Equipment, UE, to the 3GPP network via the Wu reference point (see 3GPP TS 24.234) and via the SWu reference point (see 3GPP TS 24.302).

When using a 3GPP access, the UE performs Public Land Mobile Network, PLMN, selection according to the procedures explained in 3GPP TS 23.122.

When it comes to WLAN access network selection, the WLAN UE uses scanning procedures in order to find the available networks (Service Set Identifier, SSID) and then discovers the supported PLMNs provided by the SSIDs according to 3GPP TS 24.234. WLAN network selection defined by 3GPP includes both SSID selection and PLMN selection.

Once the PLMN selection is performed by the UE, the end user is authenticated to enable their access to the 3GPP or to the WLAN and 3GPP network.

Authentication procedure when using 3GPP access network is Global System for Mobile communications, GSM, Authentication & Key Agreement, AKA, Universal Mobile Telecommunications System, UMTS, AKA or Evolved Packet System, EPS AKA. The MSC/VLR, SGSN or MME retrieves the authentication vectors from HLR/HSS to complete this procedure.

WLAN authentication signaling for 3GPP-WLAN interworking is based on Extensible Authentication Protocol, EAP, as specified in IETF RFC 3748 and RFC 5247. The EAP-Subscriber Identity Module, SIM, EAP-AKA and EAP-AKA′ methods are supported by 3GPP. The WLAN UE and the 3GPP AAA server support EAP-AKA′, EAP-AKA and EAP-SIM authentication procedures.

The recent success of mobile smartphones has also caused an increase of mobile phone theft. This has been a problem from the beginning, but due to the fact that smartphones are very expensive, has become increasingly problematic.

Today network operators address mobile phone theft by deploying Equipment Identity Register, EIR, solutions used to implement a global blacklist of stolen UEs. When a UE gets stolen, operators can block it by including a unique equipment identity of the stolen UE in the EIR database that can be contacted by the 3GPP network elements in order to accept end users network accesses if they are not making use of blacklisted UE.

The unique equipment identity can be an International Mobile Station Equipment Identity, IMEI, (14 decimal digits plus a check digit) or Mobile Station Equipment Identity Software Version, IMEISV, (16 digits), which both include information on the origin, model, and unique serial number of the device. The structure of the IMEI and IMEISV are specified in 3GPP TS 23.003.

The FIG. 1 shows an example of an end user trying to get access to a 3GPP network operator by means of a 3GPP access technology making use of a UE that is included in EIR's database blacklist. Consequently the end user is not allowed to register to the network, so cannot make use of all the services offered by the operator.

In step 1 the UE sends an Attach Request to the eNodeB, which forwards in step 2 the Attach Request to the MME. In step 3 the MME requests the subscriber identity (International Mobile Subscriber Identity, IMSI) from the UE, which returns it in step 4 to the MME. Based on this IMSI the MME performs in step 5 authentication and security related functions, also involving the subscriber database HSS. In step 6 the MME requests the IMEISV from the UE, which returns it in step 7 to the MME. In step 8 the MME initiates the equipment identity check towards the EIR. The EIR, in step 9 of this flow, determines the UE to be blacklisted, and returns in step 10 the corresponding result to the MME. The MME then in step 11 rejects the attach request of the UE with the cause Illegal UE. The rejection is forwarded by the eNodeB in step 12 to the UE.

As shown in FIG. 1, when an end user is trying to attach to the 3GPP network with mobile equipment included in the EIR blacklist, the attachment is rejected indicating the corresponding cause (Illegal UE).

However, today's smartphones are WLAN capable as well and therefore there is the possibility for an end user to access their home operator network through a WLAN Access Network, AN, for example by connecting to a public wireless Access Point, AP operated by the home operator. In such a scenario, the 3GPP network authenticates the end user (e.g. EAP-SIM, EAP-AKA, EAP-AKA′) but does not provide mechanism to prevent the end user from attaching to the network if the UE is blacklisted.

So it is possible that today a stolen and blacklisted UE can still obtain full services via a WLAN hotspot. This makes it very attractive for criminals to put focus on illegally acquiring UEs, and cause high prices for stolen smartphones on the black market.

Furthermore, current location based services do lack information about the UE hardware that is being used, so services cannot be offered based on UE's manufacturer or device type information.

A valuable use case would be in a public transport intersection location, in which a lot of stores are located (i.e. an airport or train station). WLAN hotspots are very common at those types of locations, thus many UEs are connected to WLAN rather than to 3GPP access networks, especially those that were sold by operators running the WLAN hotspots, which are usually auto-configured to prefer the operator's own WLAN in favor of costly 3GPP access.

Having information about the UE hardware available also in the WLAN network would enable the operator to commercialize this information, i.e. to sell it to UE suppliers along with the other means of contact information such as Mobile Station International Subscriber Directory Number, MSISDN, E-Mail Address, or IP Address in order to allow the UE supplier to solicit advertising matching not only the subscribers location, but also the exact UE.

### SUMMARY

In view of the above-said a need exists to improve the check on blacklisted equipment in case of network access via WLAN hotspot and wireless Access Point. Furthermore, there is a need for adaptation of network services to a particular UE type.

The need for a unique equipment identity at all type of network access requests is met by the features of the independent claims. In the dependent claims preferred embodiments of the invention are described.

The invention relates to a method for controlling access of a UE to services provided by a communication network is provided. The UE is adapted to support at least a first access technology, where said at least first access technology is associated with at least one first equipment identifier, and said first equipment identifier uniquely identifies the UE. The method comprises in the first step receiving of a network access request to services via said first access technology, said network access request comprising said first equipment identifier. The method comprises in the second step receiving of at least one additional equipment identifier not related to said first access technology, said additional equipment identifier uniquely identifying the UE. The method comprises in the third step, based on the received information, controlling of the UE's access to the services.

Furthermore, the UE may be adapted to support at least two access technologies, at least two of said supported access technologies are associated with at least one equipment identifier each, each of said equipment identifier uniquely identifying the UE.

Furthermore, the UE may be adapted to support at least one equipment identifier not related with any access technology, said equipment identifier uniquely identifying the UE.

Furthermore, the equipment identity check may be performed based on a combination of at least one of said at least one additional equipment identifier not related to said first access technology and said first equipment identifier.

Furthermore, a service check may be performed based on at least one of said at least one additional equipment identifier not related to said first access technology.

The invention, furthermore, relates to a method of a UE accessing services provided by a communication network. The UE is adapted to support at least a first access technology, said at least first access technology being associated with at least one first equipment identifier, said first equipment identifier uniquely identifying the UE. The method comprises in the first step the UE sending a network access request to services via said first access technology, said network access request comprising said first equipment identifier. The method comprises in the second step the UE sending at least one additional equipment identifier not related to said first access technology, said additional equipment identifier uniquely identifying the UE.

Furthermore, the UE may be adapted to support at least two access technologies, at least two of said supported access technologies being associated with at least one equipment identifier each, each of said equipment identifier uniquely identifying the UE.

The invention, furthermore, relates to a method of an access controller controlling access of a UE to services provided by a communication network. The access controller is adapted to handle at least two equipment identities associated with a network access request, wherein each equipment identifier uniquely identifies the UE. The method comprises in the first step the access controller receiving a network access request to services, said network access request comprising at least one first equipment identity. The method comprises in the second step the access controller receiving at least one additional equipment identity. The method comprises in the third step the access controller controlling the UE's access to the services based on the received information.

Furthermore, the access controller may send an equipment identity check request to an equipment identity register, the request comprising the received at least two equipment identifiers.

Furthermore, the access controller may send a service check request to a service database, the service check request comprising said at least two equipment identifiers.

The invention, furthermore, relates to a method of an equipment identity register checking an access permission of a UE to services provided by a communication network. The method comprises in the first step an equipment identity register receiving an equipment identity check request comprising at least two equipment identifiers, wherein each equipment identifier uniquely identifies the UE. The method comprises in the second step the equipment identity register determining, based on the received at least two equipment identifiers, whether the UE is allowed to access the services.

The invention, furthermore, relates to a UE for accessing services provided by a communication network. The UE is adapted to support at least a first access technology, said at least first access technology being associated with at least one first equipment identifier, said first equipment identifier uniquely identifying the UE.

The UE is capable of sending an access request to services via said first access technology, said access request comprising said first equipment identifier associated with said first access technology.

The UE is furthermore capable of sending at least one additional equipment identifier not related to said first access technology, said additional equipment identifier uniquely identifying the UE.

The UE may further be capable of supporting at least two access technologies, at least two of said supported access technologies being associated with at least one equipment identifier each, each of said equipment identifier uniquely identifying the UE.

The UE may furthermore be capable of supporting at least one equipment identifier not related with any access technology, said equipment identifier uniquely identifying the UE.

The invention, furthermore, relates to an access controller for controlling access of a UE to services provided by a communication network. The access controller is adapted to handle at least two equipment identities associated with a network access request, each equipment identifier uniquely identifying the UE.

The access controller is capable of receiving a network access request to services, said request comprising at least one first equipment identity.

The access controller is further capable of receiving at least one additional equipment identity;

The access controller is furthermore capable of controlling the UE's access to the services provided by the communication network, based on the received information.

The access controller may further be capable of triggering provisioning of a determined service.

The invention, furthermore, relates to an equipment identity register for verifying access permission of a UE to services provided by a communication network. The equipment identity register is adapted to handle at least two equipment identities in a verification request, each equipment identifier uniquely identifying the UE.

The equipment identity register is capable of verifying on request the access permission of the UE, said request comprising at least two equipment identities.

### BRIEF DESCRIPTION OF THE DRAWINGS

Further characteristics and advantages of the invention will become better apparent from the detailed description of particular but not exclusive embodiments, illustrated by way of non-limiting examples in the accompanying drawings, wherein:

FIG. 1 shows the 3GPP access network attach procedure flow according to prior art;

FIG. 2 shows a network scenario according to the invention;

FIG. 3a shows a schematic view of a UE adapted to perform an access request according to the invention;

FIG. 3b shows a flow diagram of the steps performed by a UE method according to the invention;

FIG. 4a shows a schematic view of an equipment identity register adapted to perform access permission verification according to the invention;

FIG. 4b shows a flow diagram of the steps performed by an equipment identity register method according to the invention;

FIG. 5a shows a schematic view of an access controller adapted to perform access control according to the invention;

FIG. 5b shows a flow diagram of the steps performed by an access controller method according to the invention;

FIG. 6 shows a procedure flow of IMEISV transfer within a single round of EAP-based access authentication;

FIG. 7 shows a procedure flow of IMEISV transfer using a second round EAP-based access authentication;

FIG. 8 shows a procedure flow of handling UE identity from different access technologies;

FIG. 9 shows a procedure flow of sending a SMS as a location based service;

FIG. 10 shows a procedure flow of a UE application registering for a location based service.

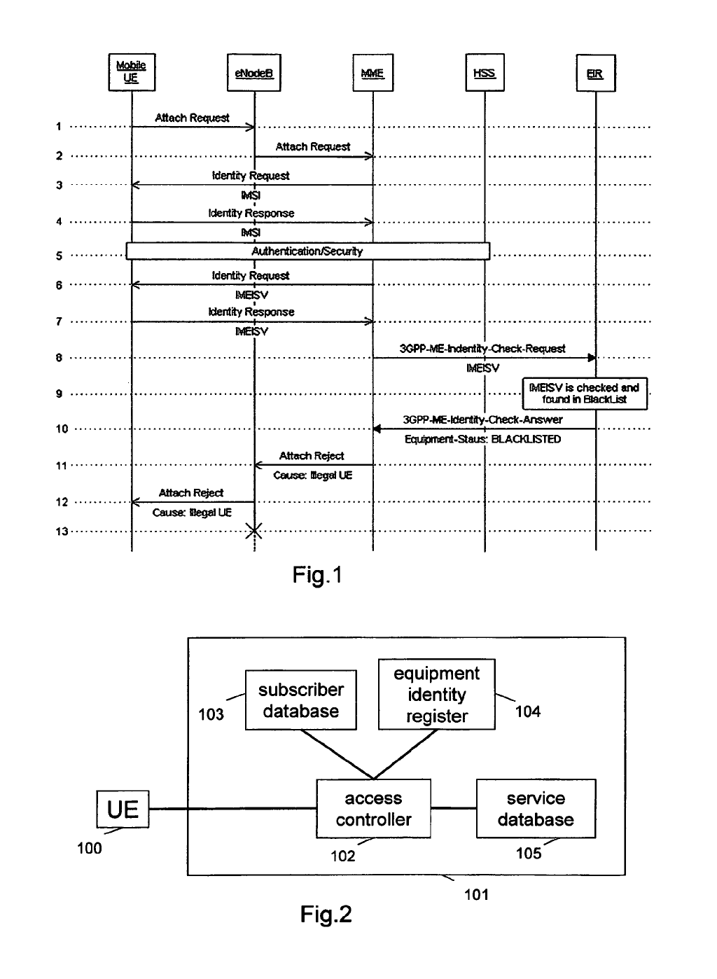

### DETAILED DESCRIPTION

Possible embodiments of the invention involve a number of different components, which are further defined in the beginning of this detailed description.

A telecommunication network refers to a collection of nodes and related transport links needed for running a service, for example telephony or Internet access. Depending on the service, different node types may be utilized to realize the service. A network operator owns the telecommunication network, and offers the implemented services to its subscribers.

User equipment, UE, refers to a device for instance used by a person for his or her personal communication. It can be a mobile telephone type of device, for example a cellular telephone, a mobile station, cordless phone, or a personal digital assistant type of device like laptop, notebook, notepad equipped with a wireless data connection. The UE may also be associated with non-humans like animals, plants, or even machines.

Subscriber database refers to a database run by the network operator to store the information related with the subscribers of a network run by the operator. A subscriber database can be for example a Home Location Register, HLR, or a Visited Location Register, VLR, or a Home Subscriber Server, HSS. A subscriber database may also be internally structured into a front end part handling the signaling with the other network nodes of the network and a generic database for storage of the data.

Equipment identity or identity refers to an identifier being unique in the sense that the same identifier will not exist a second time. Even an equipment of the same type would show a different identifier. The identifier itself consists of numbers and/or letters. The identifier may be sub-structured and the different substructures can be separated for example by hyphens, dots, or spaces. It may be constructed of a serial number combined with a product and manufacturer identifier. Examples for equipment identities are the International Mobile Equipment Identity, IMEI, as defined in 3GPP. Another example of an identifier may be a Media Access Control, MAC, address, as programmed into computer interface hardware for communications on the physical network segment. Another example of an identifier may be a Globally Unique Identifier, GUID, which is a unique reference number used as an identifier in computer software. The term GUID typically refers to various implementations of the Universally Unique Identifier, UUID standard. Another example of an identifier may be a Unique Identifier, UDID, used in certain type of mobile phones. In general a UE may comprise several identifiers, some of which may be related to the hardware of the equipment and/or the interface hardware; others may be related to the operating system software of the equipment, or other key software components running on the equipment.

Equipment identity register refers to a database for storing a list of equipment identities. This list of identities may constitute a list of all equipment explicitly not allowed to receive services from the network; in this case the list constitutes a black list of equipment identities. This list of identities may constitute a list of all equipment explicitly allowed to receive services from the network; in this case the list constitutes a white list of equipment identities. This list of identities may also constitute both, allowed and not allowed identities, and the list explicitly stores per identity whether the related equipment is allowed or not allowed to receive services from the network. An equipment identity register may also be internally structured into a front end part handling the signaling with the other network nodes of the network and a generic database for storage of the identities. An equipment identity register may be an Equipment Identity Register, EIR, as defined by the 3GPP. An equipment identity register may be operated by a network operator and in this case it contains identities of equipment associated with the network operator. As an alternative, an equipment identity register may also be operated by a third party organization and in this case it contains identities of equipment associated with a number of network operators, all of which use the equipment identity register as a central, global equipment identity register.

Service Database refers to a database for storing lists of services and the data associated with these services. The services may for example be associated with a subscriber, or with an equipment type, or with a geographical position of a UE. The service as such may for example be identified by a service identifier such that the service itself can be triggered or executed by another node in the network. The service may also be triggered or executed by the service database itself. A service database may also be internally structured into a front end part handling the signaling with the other network nodes of the network and a generic database for storage of the service data. A service database may also be realized by an IP Multimedia System, IMS, as defined by the 3GPP.

Access Controller refers to control server for controlling the access of a UE to services provided by a communication network. It may be realized by a software application on a generic server platform, or a software application in a datacenter, which is often referred to by running an application in a cloud. The Access Controller may be part of a Mobility Management Entity, MME, as defined by 3GPP, or may be part of a WLAN or Wi-Fi Gateway serving a WLAN or Wi-Fi access. The Access Controller may also be part of an Authentication, Authorization and Accounting, AAA, server controlling the network access via WLAN or Wi-Fi.

Now, with respect to FIG. 2, an exemplary network scenario for controlling the UE's access to services is show.

The UE 100 accesses the communication network 101 in order to get access to services offered by the communication network 101. The communication network 101 is operated by a network operator and comprises an access controller 102, a subscriber database 103, an equipment identity register 104, and a service database 105.

The UE 100 may access the network via a WLAN radio technology and connect to a WLAN access point, AP which transfers the access request via a WLAN gateway to an access controller 102. In this example the UE comprises a WLAN radio module and provides in its access request the MAC address associated with this WLAN radio module. In addition to the MAC address, the access controller may receive also another equipment identifier not related to the currently used WLAN radio access. The access controller 102 uses the two received equipment identifiers to control the UE's access to services provided by the communication network 101.

In another embodiment, the UE may support two access technologies, such as WLAN and UMTS. In an access request via WLAN radio the UE sends the MAC address associated with this WLAN radio module. In addition to the MAC address, the access controller may receive also an IMEI related to the UMTS access technology. The access controller 102 uses the received MAC address and the IMEI to control the UE's access to services provided by the communication network 101.

In yet another embodiment, the UE may support an equipment identity not related with any access technology, but associated with the operating system of the equipment such as a GUID. In an access request via WLAN radio the UE sends the MAC address associated with this WLAN radio module. In addition to the MAC address, the access controller may receive also a GUID related to the operating system of the UE. The access controller 102 uses the received MAC address and the GUID to control the UE's access to services provided by the communication network 101.

In a possible embodiment, the access controller 102 receives information on the subscriber from the UE. The access controller 102 with the help of a subscriber database 103 identifies the subscriber and performs security related functions.

In a possible embodiment, the access controller 102 uses an equipment identifier not related to the currently used radio access technology. So the UE may use a WLAN radio access, and may provide a MAC address associated with this WLAN radio module. The access controller 102 also receives an IMEI from the UE. The access controller 102 then uses the received IMEI in order to perform an equipment identity check.

In yet another possible embodiment, the access controller 102 may also use both received equipment identities to perform the equipment identity check. So the UE may use a WLAN radio access, and may provide a MAC address associated with this WLAN radio module. The access controller 102 also receives an IMEI from the UE. The access controller 102 then uses a combination of MAC address and IMEI to perform an equipment identity check.

The access controller 102 may use an equipment identity register 104 to perform an equipment identity check. The result of this equipment identity check is then used by the access controller 102 to determine whether the UE is granted access to the services provided by the communication network 101.

The access controller 102 may also use an equipment identifier not related to the currently used radio access technology to perform a service check. So the UE may use a WLAN radio access, and may provide a MAC address associated with this WLAN radio module. The access controller 102 also receives an IMEI from the UE. The access controller 102 then uses the received IMEI in order to perform a service check.

As described above, the equipment identifier may be substructured and one of these substructures contains information on an equipment type of the UE 100. So if an IMEI has been available in the UE 100, a serial number part of this IMEI identifies the model of the UE 100. So a service check initiated by the access controller 102 may result into a specific service being available for this model of UE 100.

Instead or in addition to the UE type, a service might be applicable to UEs at a certain geographical location. So if a UE initiates an access request at a pre-defined location, a service check done by the access controller 102 would reveal this service. In this case the access controller 102 would include information of the current location of the UE in the service check request. The access controller 102 may have received the current location of the UE from the UE, e.g. based on Global Positioning System, GPS, measurements in the UE. Alternatively the current location may be determined by the radio network, e.g. by a pre-stored information of the position of the WLAN AP and the related WLAN hotspot, or by cell information in 3GPP based radio networks.

The access controller 102 may use a service database 105 to perform a service check. In case the access controller 102 has determined applicable services for the UE by checking the service check result, the access controller 102 may trigger the provisioning of these determined services. These services may be implemented on the same server platform as the access controller 102 itself, or may also be external to the access controller 102 in other nodes of the communication network 101, or in datacenters.

In yet another possible embodiment, the access controller 102 may first initiate an equipment identity check. If, and only if the result of this equipment identity check is that the UE is allowed to access services in the communication network 101, then the access controller 102 may initiate a service check to determine possible and applicable services.

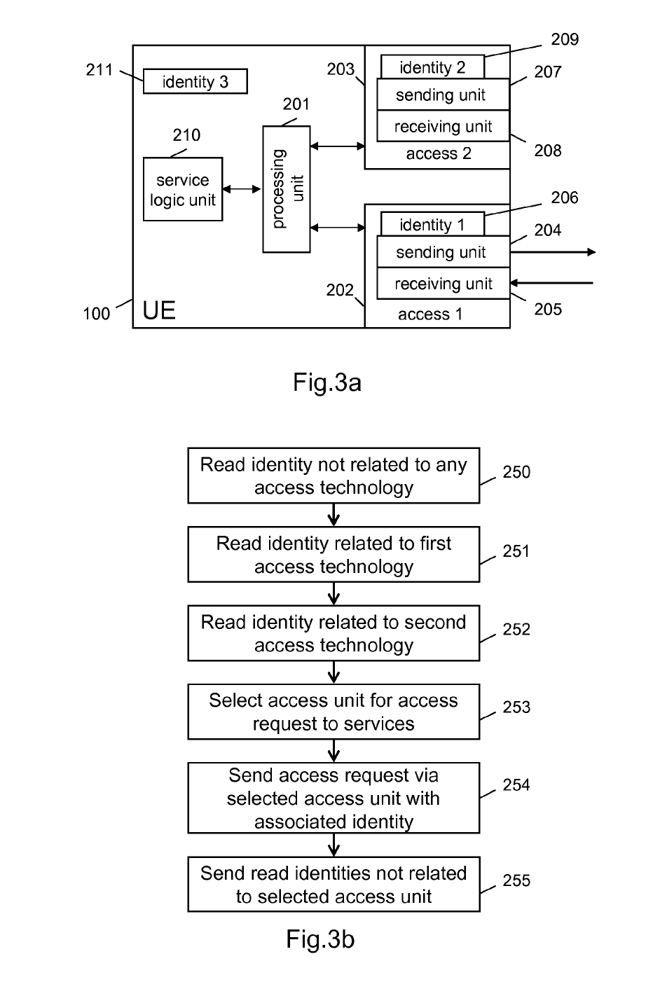

FIG. 3a shows an exemplary schematic view of a UE 100 adapted to perform the access to services as described above. The UE 100 may comprise a number of functional units, which are described in further detail below.

A processing unit 201 may be adapted to generate an access request for services, to read equipment identities from the internal components of the UE, to provide these equipment identities to the communication network 101, and to process responses from the communication network 101. The processing unit 201 is further adapted to generate service registration requests. In a practical implementation the processing unit 201 may be one processor taking care of all the above functions, or may also be distributed over more than one processor, wherein the functions are distributed over the available processors.

The UE 100 may contain one or several access units; where in this exemplary view two access units 202, 203 are shown. These access units implement different radio technologies and are used to access the communication network 101. Both access units may be active at the same time, or may be configured in a way that only one of the access units is active at a time. The access units 202, 203 are similar in a sense that both contain a sending unit 204, 207 for sending out signals and messages using a radio technology. They also both contain receiving units 205, 208 for receiving signals and messages over a radio technology. Furthermore, each access unit has its own unique identity 206, 209 associated. Examples of such access units could be WLAN access module or Wi-Fi access module, in those the identity would be a MAC address. Other examples could be GSM, UMTS, LTE, Bluetooth access modules. The access units 202, 203 are used to send out and receive signals and messages over specific access technologies to the communication network 101.

The UE 100 may contain a service logic unit 210. This unit knows about the services the user of the UE 100 want to use. This knowledge can be programmed into the service logic unit 210 by configuration means by the user. Based on the service knowledge, the service logic unit 210 generates corresponding service registration requests, which are then processed by the processing unit 201 and send out by one of the access units 202, 203.

The UE 100 may contain also other identities such as identity 211, not related to any access unit but still uniquely identifying the UE 100. These identities are stored in the UE 100 and can be read by the processing unit 201. Examples for non-access related identities are GUID, UUID, or UDID. These may be related to the operating system software or other central software elements of the UE 100.

The UE 100 may also contain functional elements used for positioning, such as a GPS receiver.

FIG. 3b shows an exemplary flow diagram of the possible steps performed by a method performed by the UE 100.

The flow may start with the reading of identities not related with any access technology in step 250. This may be done by the processing unit 201.

In the step 251 the flow continues with the reading of the identity 206 of the first access unit 202. This may be done by the processing unit 201.

In the step 252 the flow continues with the reading of the identity 209 of the second access unit 203. This may be done by the processing unit 201.

In the next step 253 an access unit is selected to be used for sending an access request for services to the communication network 101. This may be done by the processing unit 201. The selection may be based on scanning and measuring the radio environment at the current location of the UE 100. The processing unit 201 may select an access unit 202, 203 using a radio technology where high signals strength has been found during the scanning process.

At this point is shall be pointed out that the described embodiment shows only one of several options concerning the order of these four first steps. These four steps can be executed in any order without any functional different behavior.

In the next step 254 the access request to services is generated by the processing unit 201 and sent out via the selected access unit 202 or 203. Along with this request for services the identity 206 or 209 of the selected access unit 202 or 203 is sent.

Finally in step 255 also other identities are sent via the selected access unit 202 or 203 to the communication network 101, which are not related with the selected access unit.

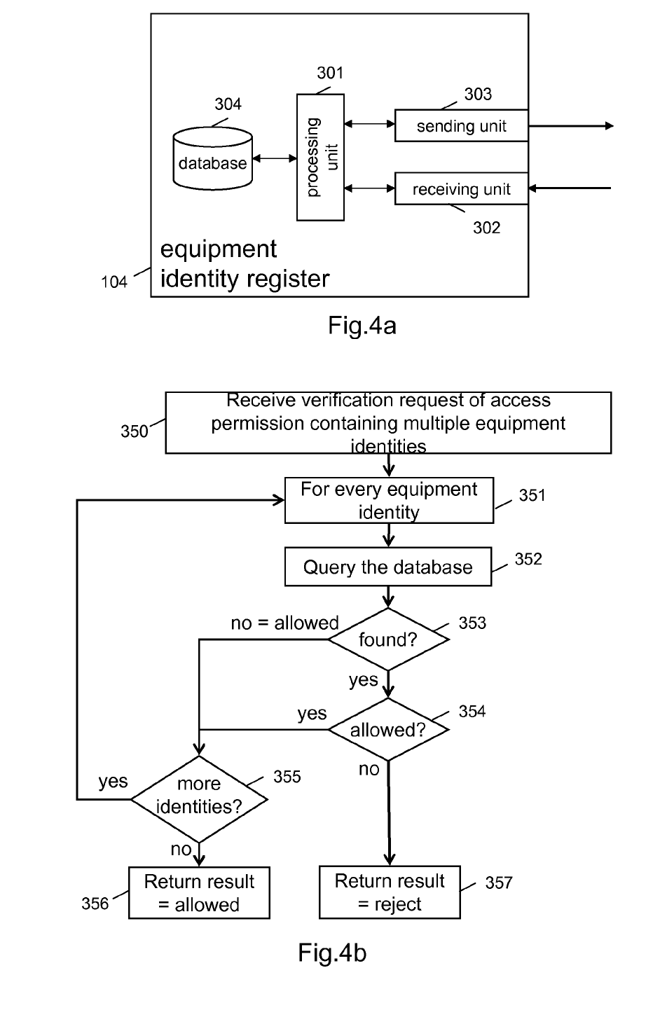

FIG. 4a shows an exemplary schematic view of an equipment identity register 104 adapted to perform the verification of access permission as described above. The equipment identity register 104 may comprise a number of functional units, which are described in further detail below.

A processing unit 301 may be adapted to process a request to verify the access permission of a UE 100, wherein the request contains more than one identity of the UE 100. The processing unit 301 may use a database query to verify the access permission. The processing unit 301 is further adapted to generate corresponding responses. In a practical implementation the processing unit 301 may be one processor taking care of all the above functions, or may also be distributed over more than one processor, wherein the functions are distributed over the available processors.

The equipment identity register 104 may further comprise a receiving unit 302 to receive requests to verify the access permission of a UE 100, wherein the request contains more than one identity of the UE 100.

The equipment identity register 104 may further comprise a sending unit 303 to send out corresponding responses to the sender of the verification request.

The equipment identity register 104 may also comprise a database 304 which stores equipment identities and optionally associated access permission.

The database 304 may contain all equipment identities explicitly not allowed to receive services from the network; in this case the database 304 constitutes a black list of equipment identities. The database 304 may contain all equipment identities explicitly allowed to receive services from the network; in this case the database 304 constitutes a white list of equipment identities. The database 304 may contain equipment identities which may be allowed or not allowed, and the database 304 explicitly stores per equipment identity whether the related equipment is allowed or not allowed to receive services from the network.

The database 304 may also be located externally to the equipment identity register 104. In this case the equipment identity register 104 has an interface to this database 304 in order to be able to place queries to the database 304 for permissions stored for an equipment identity. The database may in this case store access permissions of UEs with more than one equipment identity.

The equipment identity register 104 may deploy different algorithms to perform the verification of access permissions in the case that the request contains more than one equipment identity. The algorithm may check the permission of each of the received equipment identities, and disallows the UE's access if at least one equipment identity is found in the database 304.

Alternatively, the algorithm may check the permission of each of the received equipment identity, and disallows or allows the UE's access if the combination of the received equipment identifiers is found in the database 304. As yet another alternative, the algorithm may check the permission of each of the received equipment identity, and allows the UE's access if none of the received equipment identity is found in the database 304.

In real implementations the search in the database may be accelerated by using a hash algorithm and a database query based on the calculated hash key. The hash algorithm could use a single or multiple equipment identities as input and generate a hash key based on the input.

If a single equipment identity is used as input for the hash algorithm, the database lookup based on the resulting hash key will determine the access permission for this single equipment identity. In order to determine the access permission of the UE 100, this would have to be done for each equipment identity received in the verification request.

If multiple equipment identities are used as input for the hash algorithm, the database lookup based on the resulting hash key will determine the access permission for this combination of equipment identities and determine the access permission of the UE 100 in one database lookup step.

FIG. 4b shows an exemplary flow diagram of possible steps performed by a method performed by the equipment identity register 104. This flow shows the details of the algorithm for the case that the algorithm may check the permission of each of the received equipment identities, and disallows the UE's access if at least one equipment identifier is found in the database 304.

The flow starts with the reception 350 of a verification request of access permission containing multiple equipment identities.

Since multiple equipment identities have to be verified, in step 352 a loop is started to do the following steps for each of the received equipment identities, until either all equipment identities have been verified, or until a first equipment identity is found which is not allowed to access.

In step 352 the database 304 is queried whether the current equipment identity is found in the database 304.

If the current equipment identity is found in step 353, the stored access permission is read and verified in step 354.

If the access permission read and verified in step 354 reveals that the access is not allowed, a result is returned 357 to the sender of the access verification request indicating to reject the access request.

If the current equipment identity is not found in step 353, or if the access permission read and verified in step 354 reveals that the access is allowed, it is checked in 355 if there are more equipment identities to be checked.

If it is found in step 355 that more equipment identities have to be checked, the loop continues at step 351. Otherwise, so if all equipment identities have been checked and all have been allowed, a result is returned 356 to the sender of the access verification request indicating to allow the access request.

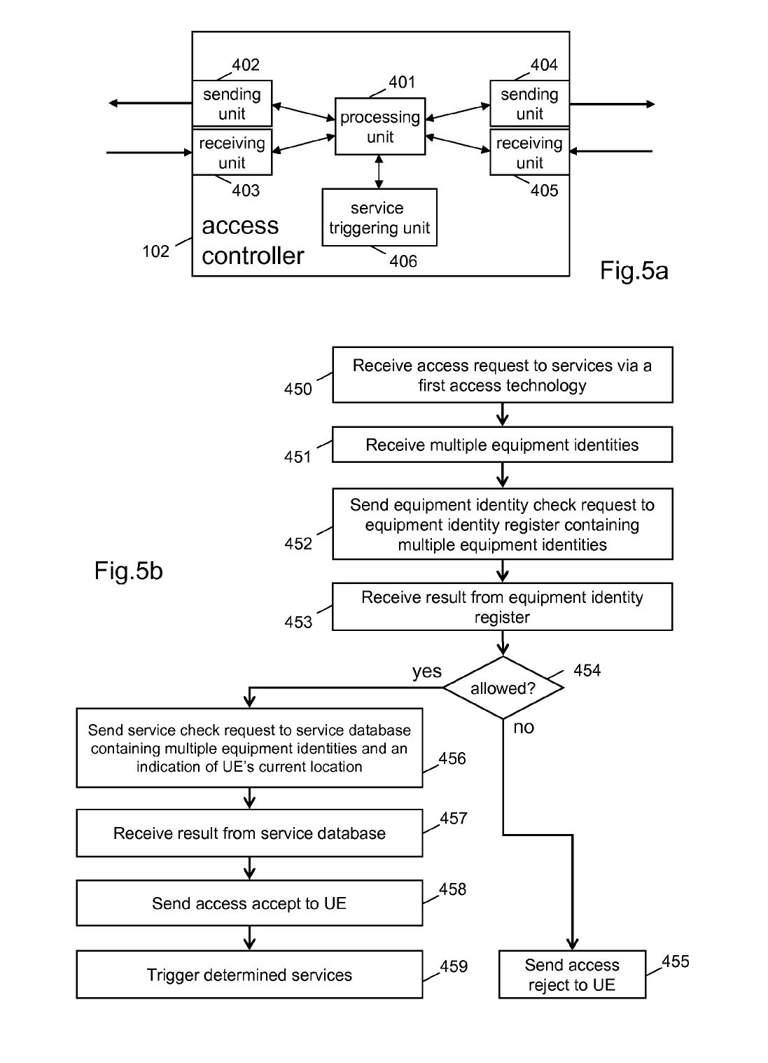

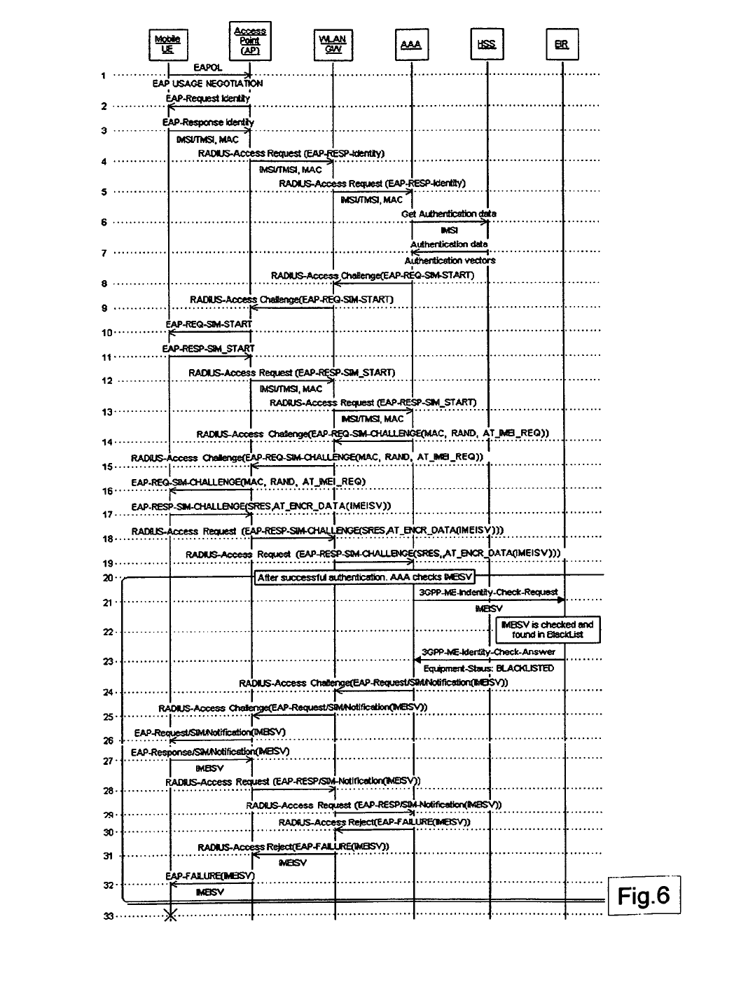

FIG. 5a shows an exemplary schematic view of an access controller 102 adapted to perform the control of access of a UE 100 to services as described above. The access controller 102 may comprise a number of functional units, which are described in further detail below.

A processing unit 401 may be adapted to process an access request to services originated by a UE 100, wherein the request may contain more than one identity of the UE 100, or further identities of the UE 100 are received in subsequent messages. The processing unit 301 may use an equipment identity register to verify the access permission of the UE 100 and/or may use a service database to check for services applicable for the UE 100. Based on the received results from an equipment identity register and/or a service database the processing unit 401 may control the UE's access to services of the communication network 101. The processing unit 401 may further be adapted to generate corresponding responses to the UE 100. In a practical implementation the processing unit 401 may be one processor taking care of all the above functions, or may also be distributed over more than one processor, wherein the functions are distributed over the available processors.

The access controller 102 may further comprise a sending unit 402 and a receiving unit 403 via which the access controller 102 can communicate with a UE 100.

The access controller 102 can also comprise a sending unit 404 and a receiving unit 405 via which the access controller 102 can communicate with other network nodes of the communication network 101, nodes such as a service database 105, an equipment identity register 104, or a subscriber database 103.

The access controller 102 may also comprise a service trigger unit 406, which can be used to trigger and control service provisioning of services determined to be applicable for a UE 100 accessing the communication network 101.

Alternatively, the access controller 102 may also consist of a single send/receive interface. This interface could then be used for both, the communication with the UE 100 and with other network nodes of the communication network 101.

FIG. 5b shows an exemplary flow diagram of possible steps performed by a method performed by the access controller 102. This flow shows the exemplary case where wherein the access controller 102 initiates an equipment identity check request first, and only if the reply from the equipment identity register 104 indicates that the UE 100 is allowed to access the communication network 101, the access controller 102 then initiates a service check request to a service database 105.

The flow may start with the access controller 102 receiving 450 an access request to services of the communication network 101. This access request is received via a first access technology.

In the next step 451 the access controller 102 may receive multiple identities of the UE 100. A first identity may be received in the access request; further identities may also be received within the same access request or may be received via subsequent messages from the UE 100.

Based on the received identities of the UE 100, the access controller 102 may send in step 452 an equipment identity check request to an equipment identity register 104. This equipment identity check request contains the received, multiple identities of the UE 100.

The response from the equipment identity register 104 is received in step 453 by the access controller 102.

The response from the equipment identity register 104 is checked in step 454 by the access controller 102. If the UE 100 has no permission to access the communication network 101, the access controller 102 returns an access reject indication to the UE 100.

If the response from the equipment identity register 104 indicates that the UE 100 has permission to access the communication network 101, the access controller 102 in step 456 sends a service check request to the service database 105. This service check request contains the received, multiple identities of the UE 100. Optionally, the service check request may contain in addition an indication of the current location of the UE 100.

In step 457 the response from the service database 105 is received by the access controller 102.

In step 458 the access controller 102 confirms to the UE 100, that it is allowed to access services of the communication network 101.

If there has been at least one service being identified by the service database 105, this service is then triggered in step 459 by the access controller 102.

Alternatively step 458, the access confirmation to the UE 100, may also be sent earlier, before sending out the service check request in step 456.

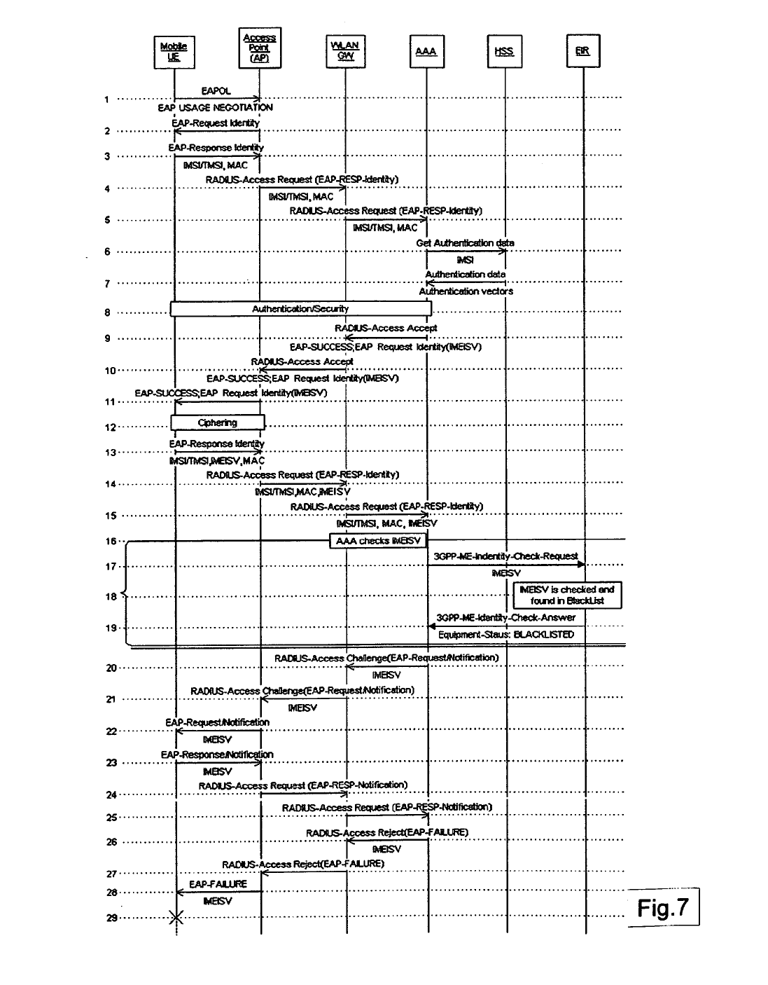

In the following a more detailed technical description of embodiments employing some of the above general concept is made. FIG. 6 shows a more detailed message flow of IMEISV transfer within a single round of EAP-based access authentication.

Entities that are involved in the message flow are a Mobile UE, which corresponds to the UE 100 as described above, an Access Point (AP), a WLAN GW, an AAA server, which corresponds to the access controller 102 as described above, a HSS, which corresponds to the subscriber database 103 as described above, and an EIR, which corresponds to the equipment identity register 103 as described above.

The detailed steps may be as follows:

1. The Mobile UE and the AP negotiate the use of EAP.
2. AP sends an EAP-Request-Identity message to the Mobile UE to obtain the end user identity.
3. The Mobile UE answers with an EAP-Response-Identity containing the subscriber identity. In the case of EAP-SIM/AKA/AKA′ the subscriber identity will be the IMSI. In addition also the MAC address will be provided.
4. The AP encapsulates the initial EAP message into a RADIUS Access-Request message and sends it to the WLAN-GW. It includes the Mobile UE's MAC address and the subscriber identity in separate Radius attributes Calling-Station-Id and User-Name respectively.
5. The WLAN-GW proxies the RADIUS Access-Request message unmodified to the AAA.
6. AAA server requests the authentication vectors from the HSS.
7. The HSS provides the authentication vectors to the AAA server.
8. The AAA server answers with RADIUS Access Challenge encapsulating the EAP-Request message (SIM, AKA, AKA′).
9. The WLAN-GW proxies the RADIUS Access-Challenge message unmodified towards the AP.
10. The AP sends an EAP-Request message to the Mobile UE.
11. The Mobile UE answers with an EAP-Response SIM-Start.
12. The AP encapsulates the EAP-Response SIM-Start message into a RADIUS Access-Request message and sends it to the WLAN-GW.
13. The WLAN-GW proxies the RADIUS Access-Request message unmodified to the AAA server.
14. The AAA server answers with a RADIUS Access Challenge encapsulating an EAP-Request SIM-Challenge message. This EAP-SIM (AKA, AKA′) message includes new information to request the Mobile UE to provide the IMEISV.
15. The WLAN-GW proxies the RADIUS Access-Challenge message unmodified towards the AP.
16. The AP extracts the EAP-Request/SIM-Challenge message and forwards it to the Mobile UE.
17. The Mobile UE processes the EAP-Request/SIM-Challenge message authenticating the network and provides the response to the challenge. Additionally, as a consequence of the request from the AAA server, the Mobile UE includes the IMEISV in the EAP-Response/SIM-Challenge message. The IMEISV is included encrypted for privacy protection inside AT_ENCR_DATA parameter.
18. The AP encapsulates that message into a RADIUS Access-Request message and sends it to the WLAN-GW.
19. The WLAN-GW proxies the RADIUS Access-Request message unmodified to the AAA server.
20. The AAA server processes the authentication procedure and successfully authenticates the subscriber. As the AAA server is aware of the reception of the IMEISV, the AAA server initiates the process to check it.
21. The AAA server queries the EIR database to check if the IMEISV is allowed or included in a black list.
22. The EIR scans its database looking for an entry for the concerned IMEISV.
23. The EIR returns a reply back towards the AAA server including the equipment status information. In this example flow the Mobile UE is blacklisted, so not allowed to access the network.
24. The AAA server processes the information received from the EIR and acts accordingly. In the example, the IMEISV is found illegal, so the AAA server generates an EAP-Request/SIM-Notification message to report the terminal about the illegal IMEISV rejection reason. If EAP-AKA or AKA′ is used, this can be done in an EAP-Request/AKA-Notification message. The message is encapsulated in a RADIUS Access-Challenge message.
25. The WLAN-GW proxies the RADIUS Access-Challenge message unmodified towards the AP.
26. The AP sends an EAP-Request/SIM-Notification message to the Mobile UE reporting the illegal IMEISV result.
27. The Mobile UE replies with EAP-Response/SIM-Notification message. If EAP-AKA or AKA′ is used this can be done in an EAP-Response/AKA-Notification message.
28. The AP includes the EAP-Response/SIM-Notification message into a RADIUS Access Request message towards the WLAN-GW.
29. The WLAN-GW proxies unmodified the RADIUS Access-Request message towards the AAA server.
30. The AAA server generates the EAP-FAILURE message embedded in an Access-Reject message to complete the EAP procedure. The AAA server may include an indication that EAP-FAILURE was triggered due to fraudulent IMEISV.
31. The WLAN-GW proxies the RADIUS Access-Reject message unmodified towards the AP.
32. The AP extracts the EAP message and sends it to the Mobile UE. The result is that the fraudulent mobile UE cannot be used with 3GPP radio access networks neither with WLAN/Wi-Fi access networks.

In the above flow sequence example RADIUS messages are used, but it is also possible to use Diameter or any other AAA protocol. The flow sequence also reflects an EAP-SIM based flow, but the process is also applicable for EAP-AKA and EAP-AKA′ cases.

In the following another more detailed technical description of embodiments employing some of the above general concept is made. FIG. 7 shows a more detailed message flow of IMEISV transfer using a second round EAP-based access authentication.

Entities that are involved in the message flow are a Mobile UE, which corresponds to the UE 100 of the general concepts, an Access Point (AP), which is not depicted in the general concepts, a WLAN GW, also not depicted in the general concepts, an AAA server, which corresponds to the access controller 102 of the general concepts, a HSS, which corresponds to the subscriber database 103 of the general concepts, and an EIR, which corresponds to the equipment identity register 103 of the general concepts.

The detailed steps may be as follows:

1. The Mobile UE and the AP negotiate the use of EAP.
2. The AP sends an EAP-Request-Identity message to the Mobile UE to obtain the end user identity.
3. Mobile UE answers with an EAP-Response-Identity containing the subscriber identity. In the case of EAP-SIM/AKA/AKA′ the subscriber is the IMSI.
4. The AP encapsulates the initial EAP message into a RADIUS Access-Request message and sends it to the WLAN-GW. The AP includes the Mobile UE's MAC address and subscriber identity in separate Radius attributes (Calling-Station-Id and User-Name respectively).
5. The WLAN-GW proxies the RADIUS Access-Request message unmodified to the AAA server.
6. AAA server requests the authentication vectors from the HSS.
7. The HSS provides the authentication vectors to the AAA server.
8. The authentication procedure is performed as well known by a person skilled in the art, so the subscriber is authenticated.
9. Once the subscriber has been successfully authenticated, the AAA server answers with successful result to the EAP procedure. The EAP message encapsulated in a RADIUS message contains additionally an Identity Request for the IMEISV. This requires a change to today's EAP protocol.
10. The WLAN-GW proxies the RADIUS Access-Accept message unmodified to the AP.
11. The AP extracts the EAP messages and sends them to the Mobile UE. At this point, although authenticated, the AP may keep ports blocked until a second authentication round is provided with the IMEISV, as explained in next steps. Consequently the Mobile UE cannot run traffic until the IMEISV is positively verified.
12. The Mobile UE and the AP negotiate the ciphering keys. Communication from now on is encrypted.
13. The Mobile UE answers with an EAP-Response SIM/AKA/AKA′-Start.
14. The AP encapsulates the EAP-Response message into a RADIUS Access-Request message and sends it to the WLAN-GW. IMEISV and MAC address are included in this message.
15. The WLAN-GW proxies the RADIUS Access-Request message unmodified towards the AAA server.
16. The AAA server determines that this Access Request corresponds to an EAP session for IMEISV check, from an already authenticated user. This is done by checking that it contains an EAP-Message Radius attribute with the IMEISV and the AAA server is aware that the subscriber with the TMSI/IMSI and MAC received has already been authenticated.
17. The AAA server queries the EIR database to check if the IMEISV is allowed or included in a black list.
18. The EIR scans its database looking for an entry for the concerned IMEISV.
19. The EIR returns back towards the AAA server the equipment identity status information. In the example flow the UE is blacklisted.
20. The AAA server processes the information received from the EIR and acts accordingly. In this example flow, the IMEISV is found to be illegal. Therefore a notification (EAP-Request/Notification) is delivered to the Mobile UE by embedding it in an RADIUS Access-Challenge message.
21. The WLAN-GW proxies the RADIUS Access-Challenge message unmodified towards the AP.
22. The AP extracts the EAP message and sends it to the Mobile UE. This results into that that the fraudulent Mobile UE cannot be used with 3GPP radio access networks neither with WLAN/Wi-Fi access networks.
23. The Mobile UE replies to the EAP-Request/Notification message with an EAP-Response/Notification.
24. The AP includes the EAP-Response/Notification message into a RADIUS Access Request message towards the WLAN-GW.
25. The WLAN-GW proxies the RADIUS Access-Request message unmodified to the AAA server.
26. The AAA server generates an Access-Reject message with EAP-FAILURE indication to complete the EAP procedure.
27. The WLAN-GW proxies the RADIUS Access-Reject message unmodified to the AP.
28. The AP extracts the EAP message and sends it to the Mobile UE. The result is that the fraudulent mobile UE cannot be used with 3GPP radio access networks neither with Wi-Fi access network.

In the above example flow sequence RADIUS is used, but it is also possible to use Diameter or any other AAA protocol.

In the above example flow sequence EAP Notifications are used. It is also possible to use method specific notifications, for example SIM/AKA/AKA′-Notifications.

In the above example flow sequence, it is assumed that EAP-SIM, EAP-AKA and/or EAP-AKA′ were extended to support a second round of EAP exchange for IMEISV check, see step 13. Alternatively, other EAP methods may be used for this second round of EAP exchange. For example, after the initial EAP-SIM, EAP-AKA or EAP-AKA′ has completed in step 11 a different EAP method such as EAP-MD5 can be used to request and transfer the IMEISV.

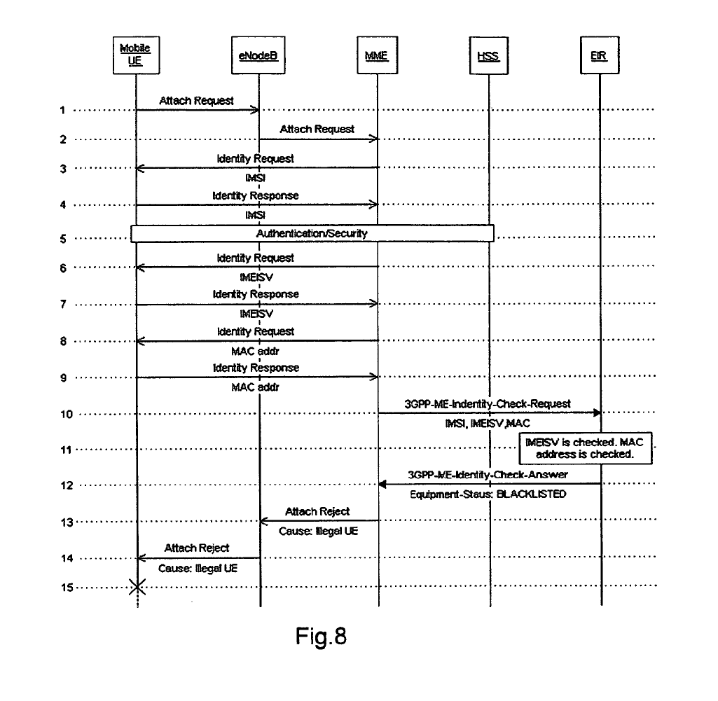

In the following another more detailed technical description of embodiments employing some of the above general concept is made. FIG. 8 shows a procedure flow of handling UE identifier from different access technologies.

Entities that are involved in the message flow are a Mobile UE, which corresponds to the UE 100 of the general concepts, an eNodeB, which is not depicted in the general concepts, an MME, which corresponds to the access controller 102 of the general concepts, a HSS, which corresponds to the subscriber database 103 of the general concepts, and an EIR, which corresponds to the equipment identity register 103 of the general concepts.

The sequence of FIG. 8 shows the procedure of an end user trying to get access to a 3GPP network by means of a 3GPP access technology making use of a Mobile UE that is included in EIR's database blacklist, enhanced to consider not only the IMEISV but also the MAC address of the Mobile UE.

The detailed steps may be as follows:

1. The Mobile UE sends an Attach Request message towards the selected eNodeB to access the 3GPP network.
2. The eNodeB forwards the request to the MME.
3. The MME requests the subscriber identity, for example the IMSI, to authenticate the subscriber.
4. The Mobile UE provides the subscriber identity towards the MME.
5. The subscriber is authenticated and the process for secure communication is completed.
6. MME requests to the Mobile UE for the IMEISV, to check if the subscriber is using a fraudulent Mobile UE.
7. The Mobile UE provides the IMEISV towards the MME.
8. The MME requests additionally the MAC address from the Mobile UE, to be used together with the IMEISV in the equipment identity checking process. The MAC address is a new value in the existing information element of the Identity Request message.
9. The MME receives the MAC address.
10. The MME queries the EIR database with both, the MAC address and the IMEISV.
11. The EIR not only checks if the IMEISV is blacklisted but also if the MAC address is blacklisted. The EIR could provide as well a correlation between IMSI/MAC, IMEI/MAC or IMSI/MAC/IMEI.
12. The EIR provides the result of the identity check to the MME. In this example flow the Mobile UE is blacklisted, so not allowed to access the 3GPP network.
13. The MME triggers an Attach Reject message towards the Mobile UE.
14. The eNodeB forwards the Attach Reject towards the Mobile UE.

Consequently the Mobile UE cannot be used to access the 3GPP network.

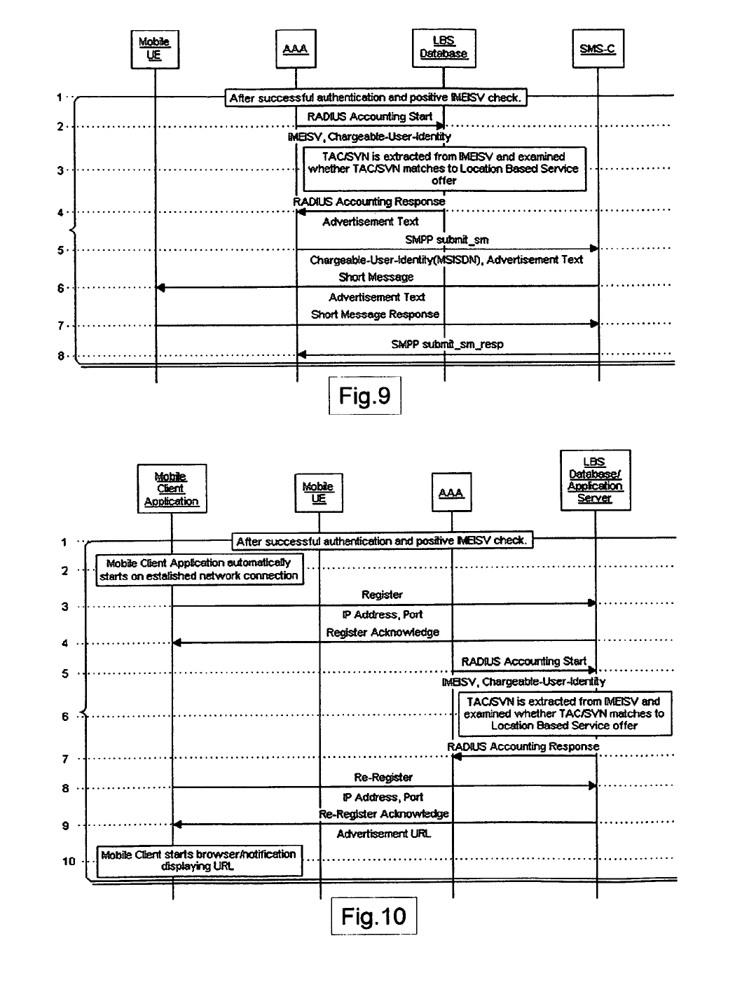

In the following another technical description of embodiments employing some of the above general concept is made. FIG. 9 shows a procedure flow of sending a SMS as a location based service.

Entities that are involved in the message flow are a Mobile UE, which corresponds to the UE 100 of the general concepts, an AAA, which corresponds to the access controller 102 of the general concepts, a Location Based Service, LBS, Database, which corresponds to the service database 105 of the general concepts, and a SMS-Center, SMS-C, which is responsible of executing a service, here to send a SMS to the Mobile UE.

The high level steps may be as follows:

1. The Mobile UE is successfully authenticated and IMEISV and MAC address is allowed to access the services provided by the network.
2. The AAA server requests a service check by initiating a RADIUS accounting. The AAA server submits the IMEISV in the Attribute Value Pairs, AVP, 3GPP-IMEISV and corresponding MSISDN in the AVP Chargeable User Id.
3. The LBS Database checks for applicable and matching location based services.
4. The LBS Database returns a RADIUS Accounting Response, including an indication of a matching service, here a matched advertisement text.
5. The AAA server triggers the execution of the service, here delivery of the received advertisement text. For this the AAA server sends the text and the MSISDN of the receiving subscriber towards a SMS-C.
6. The SMS-C delivers the text in form of one or several SMS to the Mobile UE.
7. The Mobile UE confirms the reception of the SMS in a response to the SMS-C.
8. The SMS-C confirms the execution of the service in a response to the AAA server.

In the following another more detailed technical description of embodiments employing some of the above general concept is made. FIG. 10 shows a procedure flow of a UE application registering for a location based service.

Entities that are involved in the message flow are a Mobile Client Application, which may be a software application running on the Mobile UE, a Mobile UE, which corresponds to the UE 100 of the general concepts, an AAA, which corresponds to the access controller 102 of the general concepts, a Location Based Service, LBS, Database, which corresponds to the service database 105 of the general concepts. Alternatively, instead of a Location Based Service Database, other service execution application servers may be used.

The high level steps in case of a service application server may be as follows:

1. The Mobile UE is successfully authenticated and IMEISV and MAC address are allowed to access the services provided by the network.
2. The Mobile UE detects an established network connection and automatically starts a service related Mobile Client Application.
3. The Mobile Client Application registers at the service application server for a service.
4. The service application server acknowledges the registration of a service.
5. At service execution triggering, the AAA server initiates a RADIUS Accounting message to submit the IMEISV in an AVP 3GPP-IMEISV to the service application server.
6. The service application server checks for applicable and matching services.
7. The service application server returns a RADIUS Accounting Response message to the AAA server including an indication of matching services.
8. Periodically, to refresh the service registration, the Mobile Client Application re-registers at the service application server after expiration of a service registration timer.
9. The service application server acknowledges the service re-registration, and, for example, returns in this acknowledgement an advertisement Universal Resource Locator, URL.
10. The Mobile Client Application starts a web browser application on the Mobile UE, which is displaying the web page corresponding to the URL.

1-37. (canceled)

38. A method of controlling access of a user equipment (UE) to services provided by a communication network, the UE being adapted to support at least a first access technology, said at least first access technology being associated with at least one first equipment identifier, said first equipment identifier uniquely identifying the UE, and said method comprising the steps of:
receiving a network access request to services via said first access technology, said network access request comprising said first equipment identifier;
receiving at least one additional equipment identifier not related to said first access technology, said additional equipment identifier uniquely identifying the UE; and
based on the received information, controlling the UE's access to the services.

39. The method of claim 38, wherein the UE is adapted to support at least two access technologies being associated with at least one equipment identifier each, each of said equipment identifiers uniquely identifying the UE.

40. The method of claim 38, wherein the UE is adapted to support at least one equipment identifier not related with any access technology, said equipment identifier uniquely identifying the UE.

41. The method of claim 38, wherein an equipment identity check is performed based on at least one of said at least one additional equipment identifier not related to said first access technology.

42. The method of claim 41, wherein the equipment identity check is performed based on a combination of at least one of said at least one additional equipment identifier not related to said first access technology and said first equipment identifier.

43. The method of claim 41, wherein the equipment identity check determines whether the UE is allowed to access the services.

44. The method of claim 38, wherein a service check is performed based on at least one of said at least one additional equipment identifier not related to said first access technology.

45. The method of claim 44, wherein at least one received equipment identifier contains information on an equipment type of the UE, and said service check determines at least one service being available for this equipment type of the UE.

46. The method of claim 44, wherein said service check is based in addition on a current location of the UE.

47. The method of claim 46, wherein said service check determines at least one service being available for this UE at the current location of the UE.

48. The method of claim 44, wherein the result of said service check triggers the provisioning of the determined at least one service.

49. The method of claim 38, wherein the UE sends a registration request for registering for at least one service.

50. A method of a user equipment (UE) accessing services provided by a communication network, the UE being adapted to support at least a first access technology, said at least first access technology being associated with at least one first equipment identifier, said first equipment identifier uniquely identifying the UE, and said method comprising the steps of:
the UE sending a network access request to services via said first access technology, said network access request comprising said first equipment identifier; and
the UE sending at least one additional equipment identifier not related to said first access technology, said additional equipment identifier uniquely identifying the UE.

51. The method of claim 50, wherein the UE is adapted to support at least two access technologies, at least two of said supported access technologies are associated with at least one equipment identifier each, each of said equipment identifier uniquely identifying the UE.

52. The method of claim 50, wherein the UE is adapted to support at least one equipment identifier not related with any access technology, said equipment identifier uniquely identifying the UE.

53. The method of claim 50, wherein the UE sends a registration request for registering for at least one service.

54. A method of an access controller controlling access of a user equipment (UE) to services provided by a communication network, the access controller being adapted to handle at least two equipment identities associated with a network access request, each equipment identifier uniquely identifying the UE, and said method comprising the steps of:
the access controller receiving a network access request to services, said network access request comprising at least one first equipment identity;
the access controller receiving at least one additional equipment identity; and
the access controller based on the received information, controlling the UE's access to the services.

55. The method of claim 54, wherein the access controller sends an equipment identity check request to an equipment identity register, the request comprising the received at least two equipment identifiers.

56. The method of claim 54, wherein the access controller based on the received reply from the equipment identity register, accepts or rejects the UE's network access request.

57. The method of claim 54, wherein at least one equipment identifier contains information on an equipment type of the UE.

58. The method of claim 54, wherein the access controller sends a service check request to a service database, the service check request comprising said at least two equipment identifiers.

59. The method of claim 58, wherein said service check request comprises in addition an indication of a current location of the UE.

60. The method of claim 54, wherein the access controller receives a reply from the service database, said reply indicating at least one determined service, and wherein the access controller triggers the provisioning of said at least one determined service.

61. The method of claim 54, wherein the access controller initiates an equipment identity check request first, and only if the reply from the equipment identity register indicates that the UE is allowed to access, the access controller initiates a service check request to a service database.

62. A method of an equipment identity register checking an access permission of a user equipment (UE) to services provided by a communication network, the method comprising the steps of:
an equipment identity register receiving an equipment identity check request comprising at least two equipment identifiers, wherein each equipment identifier uniquely identifies the UE; and
the equipment identity register determining based on the received at least two equipment identifiers, whether the UE is allowed to access the services.

63. The method of claim 62, wherein the equipment identity register disallows the UE's access if at least one of said at least two equipment identifiers matches with a pre-stored reference.

64. The method of claim 62, wherein the equipment identity register disallows the UE's access if a combination of said at least two equipment identifiers matches with a pre-stored reference.

65. The method of claim 62, wherein the equipment identity register allows the UE's access if none of said at least two equipment identifiers is found in a pre-stored reference.

66. A user equipment (UE) for accessing services provided by a communication network, the UE being adapted to support at least a first access technology, said first access technology being associated with at least one first equipment identifier, said first equipment identifier uniquely identifying the UE, and said UE configured to:
sending an access request to services via said first access technology, said access request comprising said first equipment identifier associated with said first access technology; and
sending at least one additional equipment identifier not related to said first access technology, said additional equipment identifier uniquely identifying the UE.

67. The UE of claim 66, being further configured to support at least two access technologies, at least two of said supported access technologies are associated with at least one equipment identifier each, each of said equipment identifier uniquely identifying the UE.

68. The UE of claim 66, being further configured to support at least one equipment identifier not related with any access technology, said equipment identifier uniquely identifying the UE.

69. The UE of claim 66, being further configured to send a registration request for registering for at least one service.

70. An access controller for controlling access of a user equipment (UE) to services provided by a communication network, said access controller configured to:
handle at least two equipment identities associated with a network access request, each equipment identifier uniquely identifying the UE;
receive network access request to services, said request comprising at least one first equipment identity;
receive at least one additional equipment identity; and
based on the received information, control the UE's access to the services provided by the communication network.

71. The access controller of claim 70, being further configured to trigger provisioning of a determined service.

72. An equipment identity register for verifying access permission of a user equipment (UE) to services provided by a communication network, said equipment identity register configured to:
handle at least two equipment identities in a verification request, each equipment identifier uniquely identifying the UE; and
verify, on request, the access permission of the UE, said request comprising at least two equipment identities.

73. The equipment identity register of claim 72, wherein the equipment register further comprises a database storing access permissions of UEs with at least two equipment identifiers.

74. The equipment identity register of claim 72, wherein the equipment register further comprises an interface to an external database storing access permissions of UEs with at least two equipment identifiers.
